(19) United States
(12) Patent Application Publication
(10) Pub. No.: US 2023/0123759 A1
(43) Pub. Date: Apr. 20, 2023

(54) DIGITAL WALLET FRAUD GUARD

(71) Applicant: American Express Travel Related Services Company, Inc., New York, NY (US)

(72) Inventor: Shahriar ZAND-BIGLARI, Phoenix, AZ (US)

(73) Assignee: American Express Travel Related Services Company, Inc., New York, NY (US)

(21) Appl. No.: 17/662,616

(22) Filed: May 9, 2022

Related U.S. Application Data
(63) Continuation of application No. 14/987,100, filed on Jan. 4, 2016, now abandoned.

(51) Int. Cl. G06Q 20/40; G06Q 20/36; G06Q 20/38

(52) U.S. Cl. CPC G06Q 20/4016; G06Q 20/3674; G06Q 20/389; G06Q 20/4014; G06Q 20/4015

(57) ABSTRACT

Systems and methods of improving the operation of a transaction network and transaction network devices through use of a digital wallet fraud guard system are disclosed. A digital wallet fraud guard system may comprise various modules and engines, wherein the probability that a transaction is fraudulent may be evaluated for establishing better secured usage of transaction instruments. For instance, a triggered alert indication may visually indicate to an account user a fraud risk associated with a potential transaction prior to the exposure of the transaction instrument. In this manner, the transaction network more properly functions according to approved parameters by diminishing the risk of data loss and lessening the value of the transaction network as a target for fraud and thus network intrusions and disruptions.

### FIELD

The present disclosure relates to fraud prevention for electronic transaction systems.

### BACKGROUND

Large data sets may exist in various sizes and levels of organization, and are frequently controlled by transaction account issuers. With big data comprising data sets as large as ever, the volume of data collected incident to the increased popularity of online and electronic transactions continues to grow. Billions of rows and hundreds of thousands of columns worth of data may populate a single table, for example. An example of the use of big data is in identifying potentially fraudulent transactions, which is frequently a key priority for transaction account issuers. However, transactions processed by the transaction account issuer are massive in volume and comprise tremendously large data sets.

Transaction account issuers expend significant time and resources in identifying and preventing fraudulent transactions. Prior mechanisms of identifying fraudulent transactions typically involved evaluating aspects of the transaction after the transaction is at least partially instantiated. For instance, such mechanisms frequently deny a transaction following the exposure of the transaction account information.

Frequently, such potentially fraudulent transactions are identified following the exposure of the transaction account information. As such, fraudulent transactions are frequently executed before identification, hampering the security of the electronic networks involved. For example, this may involve exposing transaction account information to hackers and diminishing the efficiency and reliability of the transaction processing network, confusing and frustrating the identification and categorization of transaction data and exacerbating the frequency of fraudulent traffic across the transaction processing network.

### SUMMARY

A digital wallet fraud guard system may include a digital wallet fraud guard agent including a process running on a mobile device. The system may be configured to monitor a usage of a digital wallet and electronic credentials associated with the digital wallet, wherein the digital wallet fraud guard agent transmits transaction context data to a mobile device communication channel. The system may also include a digital wallet fraud guard service including a process running on a transaction account provider data center and configured to receive the transaction context data from the mobile device communication channel and configured to transmit threat assessment data (including at least one of threat details, threat level, or a short information) to the mobile device via the mobile device communication channel.

In various embodiments, the digital wallet fraud guard agent is configured to provide a fraud threat assessment to a user in response to the threat assessment data. Moreover, the transaction context data may include at least one of geolocation data, a device ID, or a token identifying at least one of a transaction account holder and transaction account of an electronic credential. The digital wallet fraud guard agent may be configured to receive a first user input, the first user input including at least one of a selection of a merchant from among a list of merchants in response to geolocation data, and a textual entry of a merchant name, wherein the transaction context data includes the first user input. Furthermore, the digital wallet fraud guard agent may include a triggered alert indicator wherein a fraud threat assessment is communicated in a human readable form to a user. The triggered alert indicator may include a visual display of different colors, each indicating a relative degree of fraud risk. The merchant fraud threat database may be in communication with the digital wallet fraud guard service and may be configured to store a fraud threat assessment in association with the transaction context data. The internal back end services may be in direct communication with the digital wallet fraud guard service via a back-end-to-service channel, and may include at least one of big data services, transaction analytics, transaction account data, transaction account holder data, and merchant data.

A method of digital wallet fraud guard threat indication may include receiving, by a digital wallet fraud guard agent, a user command to open a digital wallet, sending, by the digital wallet fraud guard agent, transaction context data to a digital wallet fraud guard service of a transaction account provider data center, preparing, by the digital wallet fraud guard service, a threat level and a short information, receiving by the digital wallet fraud guard agent the threat level and the short information, and activating, by the digital wallet fraud guard agent, a triggered alert indicator in response to the threat level and the short information, wherein the triggered alert indicator is configured to display a threat level indication.

In various embodiments, the transaction context data includes at least one of geolocation data, a device ID, or a token identifying at least one of a transaction account holder or transaction account of an electronic credential. The digital wallet fraud guard agent may be configured to receive a first user input, the first user input including at least one of a selection of a merchant from among a list of merchants in response to geolocation data, and a textual entry of a merchant name, wherein the transaction context data includes the first user input. The triggered alert indicator may communicate a fraud threat assessment in a human readable form to a user. The triggered alert indicator may include a visual display of different colors, each indicating a relative degree of fraud risk. In various embodiments, the digital wallet fraud guard service is in communication with a merchant fraud threat database configured to store a fraud threat assessment in association with transaction context data. The digital wallet fraud guard service may be in communication with an internal back end service including at least one of big data services, transaction analytics, transaction account data, transaction account holder data, and merchant data. The method may also include a method of digital wallet fraud guard detail disclosure, including receiving, by the digital wallet fraud guard agent, the user command to access threat details, transmitting, by the digital wallet fraud guard agent, a request for the threat details to the digital wallet fraud guard service of the transaction account provider data center, preparing, by the digital wallet fraud guard service, the threat details, receiving, by the digital wallet fraud guard agent, the threat details, and displaying, by the digital wallet fraud guard agent, the threat details, in response to the threat details.

A method of digital wallet fraud guard detail disclosure may include receiving, by a digital wallet fraud guard agent, a user command to access threat details, transmitting, by the digital wallet fraud guard agent, a request for the threat details to a digital wallet fraud guard service of a transaction account provider data center, preparing, by the digital wallet fraud guard service, the threat details, receiving, by the digital wallet fraud guard agent, the threat details, and displaying, by the digital wallet fraud guard agent, the threat details, in response to the threat details.

In various embodiments, the method further includes the digital wallet fraud guard agent being configured to receive a first user input including at least one of a selection of a merchant from among a list of merchants in response to geolocation data, or a textual entry of a merchant name. The threat details may be associated with the selected merchant. Moreover, a triggered alert indicator may communicate the threat details in a human readable form to a user. Furthermore, the digital wallet fraud guard service may be in communication with a merchant fraud threat database configured to store the threat details in association with transaction context data.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 illustrates an exemplary digital wallet fraud guard system, in accordance with various embodiments;

FIG. 2A illustrates an exemplary method of digital wallet fraud guard threat, in accordance with various embodiments;

FIG. 2B illustrates an exemplary method of digital wallet fraud guard threat detail disclosure, in accordance with various embodiments; and

FIG. 3 illustrates further aspects of exemplary digital wallet fraud guard system, specifically a triggered alert indicator, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, various aspects may interact with distributed storage system for storage and/or processing of big data sets. As used herein, big data may refer to partially or fully structured, semi-structured, or unstructured data sets including millions of rows and hundreds of thousands of columns, A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

In various embodiments, data may comprise a collection of data including and/or originating from accountholder information, transaction information, account information, record of sales, account history, customer history, sensor data, machine log data, data storage system, public web data, and/or social media. Data may be collected from multiple sources and amalgamated into a big data structure such as a file, for example. In that regard, the data may be used as an input to generate metadata describing the big data structure itself, as well as the data stored in the structure.

The distributed storage system may comprise a transaction network. A transaction network host may comprise various modules and engines as discussed herein wherein the probability that a transaction is fraudulent may be evaluated for establishing proper usage of differentiated transaction instruments according to their proper purposes.

Prior fraud detection mechanisms typical focus on transaction level fraud prevention. In other words, once a transaction begins, for instance, a card is swiped, or a digital wallet is exposed to a point of sale and a transaction initiated, the proposed transaction is evaluated for potential fraud and blocked in response to the likelihood that the transaction is fraudulent exceeding a threshold. However, in many scenarios, by the time the wallet or transaction account is exposed, it is too late to prevent fraud using prior fraud detection mechanisms. In various instances, the “transaction context” may be said to be compromised. For instance, aspects of a vendor system may be compromised so that the initiation of the transaction exposes sufficient information to permit fraudulent use of the transaction instrument, such as the transaction account or digital wallet.

As such, in various embodiments, an early assessment of a transaction context may be performed by a transaction device having a digital wallet stored thereon. For instance, a transaction device may be a smartphone with a digital wallet thereon. In response to launching the digital wallet, but before the transaction instrument stored in the digital wallet is exposed, the digital wallet may display a visual indication of the risk of transaction fraud associated with the transaction context. Moreover, the digital wallet may further provide to a transaction account issuer a notification of the risk of transaction fraud associated with the transaction context, and/or the transaction account issuer may already have such risk data, so that the processing of the transaction may be tailored to the relative risk level (for instance, additional end-to-end encryption using preshared keys, or selection of a different transaction network).

Thus digital wallet fraud guard technology may include a fraud threat awareness and fraud prevention capability which may be incorporated into digital wallets such as Apple Passbook, ApplePay, Google Wallet. Samsung Pay, AMEX Digital Wallet, etc., wherein the mobile digital wallet user may be alerted to the presence of a fraud threat. In various embodiments, such alerting is done through an icon depicting different colors in response to different degrees of risk, for instance Green (no known fraud threat) yellow (potential of fraud threat) and red (high potential of fraud threat). In various embodiments, the digital wallet fraud guard will utilize the geolocation function of the mobile device (such as mapped to county, city, zip code, merchant, etc.) and other information to assess the degree of risk. In various embodiments, a digital wallet containing a transaction account issued by a transaction account provider may provide additional capabilities tied to the user's transaction account.

Moreover, while various aspects are discussed with reference to transaction accounts, in various embodiments, various aspects of the disclosure herein may be implemented with other electronic credentials, for instance, digital passports, digital identification, digitally stored medical information, etc.

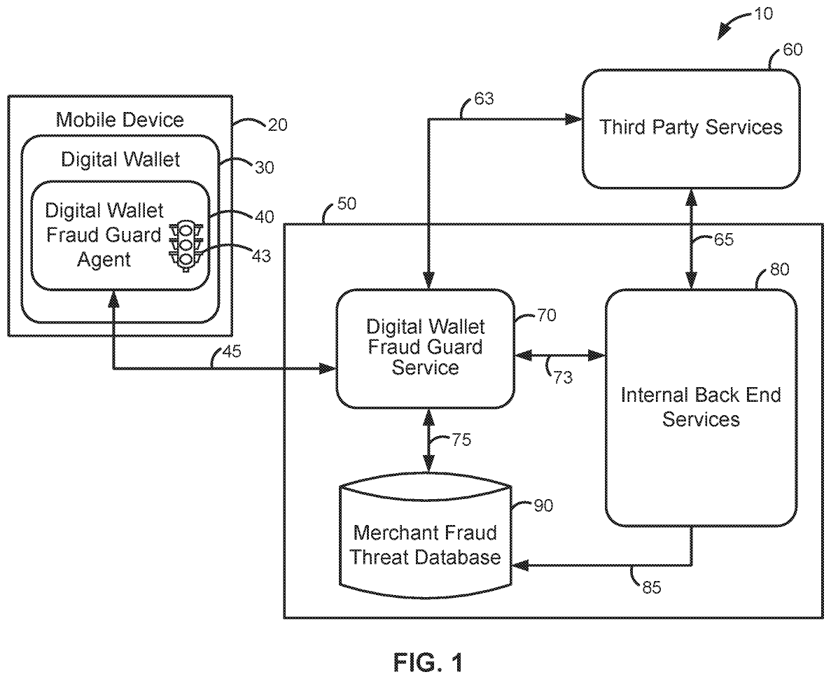

With reference to FIGS. 1-3, various aspects of a digital wallet fraud guard system 10 are disclosed herein. For instance, with specific reference to FIG. 1, a digital wallet fraud guard system 10 may comprises several components and may be configured to provide a fraud threat assessment to a user.

A digital wallet fraud guard system 10 may comprise a mobile device 20. A mobile device 20 may comprise a smartphone, for instance an iPhone® device or a BlackBerry® device or an Android® device, or any device capable of instantiating an electronic financial transaction. In various embodiments, the mobile device 20 is in electronic communication with a transaction account provider data center 50 via a mobile device communication channel 45.

A digital wallet fraud guard system 10 may comprise a transaction account provider data center 50. The transaction account provider data center 50 may be configured to receive transaction context data from the mobile device 20 via the mobile device communication channel 45 and to transmit threat assessment data (for instance, threat details, threat level, and/or short info, as discussed further herein) to the mobile device 20 via the mobile device communication channel 45.

The digital wallet fraud guard system 10 may comprise a mobile device communication channel 45. The mobile device communication channel 45 may comprise a network. For instance, the mobile device communication channel 45 may comprise an electronic data connection such as via the internet.

The digital wallet fraud guard system 10 may comprise third party services 60. Third party services 60 may comprise geolocation services, merchant data such as provided by a merchant that is a party to a potential transaction, social media data, such as may be provided by a transaction account holder regarding transaction contexts, and/or the like. The transaction account provider data center 50 may be in communication with one or more third party service 60 via a third party service backend channel 65 and/or a third party service fraud guard channel 63. The third party service backend channel 65 and/or a third party service fraud guard channel 63 may comprise a network. For instance, the third party service backend channel 65 and/or a third party service fraud guard channel 63 may comprise an electronic data connection such as via the internet.

The mobile device 20 may comprise further aspects. Alternatively, the digital wallet fraud guard system 10 may be said to comprise further aspects which are associated with a mobile device 20. For instance the digital wallet fraud guard system 10 may comprise a digital wallet 30.

A digital wallet 30 may comprise a data store reposed in a memory of the mobile device 20 and configured to permit a user of the mobile device 20 to retrieve electronic credentials, such as transaction accounts, digital passports, digital identification, digitally stored medical information, and/or the like.

The digital wallet fraud guard system 10 may further comprise a digital wallet fraud guard agent 40. A digital wallet fraud guard agent 40 may comprise a process running on the mobile device and a logical partition of the digital wallet 30 configured to monitor the usage of the digital wallet 30 and stored electronic credentials associated with the digital wallet and configured to communication with aspects of the transaction account provider data center 50 via the mobile device communication channel 45, wherein a fraud threat assessment may be provided to a user. In various embodiments, the digital wallet fraud guard agent 40 is configured to send at least one of geolocation data, device ID, and/or a token identifying the transaction account holder and/or transaction account of an electronic credential within the digital wallet 30 via the mobile device communication channel 45 to an aspect of the transaction account provider data center 50 (such as a digital wallet fraud guard service 70). Moreover, the digital wallet fraud guard agent 40 may accept user input, such as selection of a merchant to be a transaction counterparty from among a list of merchants in response to geolocation data indicating multiple proximate merchants in the transaction context. The digital wallet fraud guard agent 40 may accept user input such as receiving textual input (such as a merchant name and/or other information) in the event that geolocation is not possible—such as for a mobile street merchant.

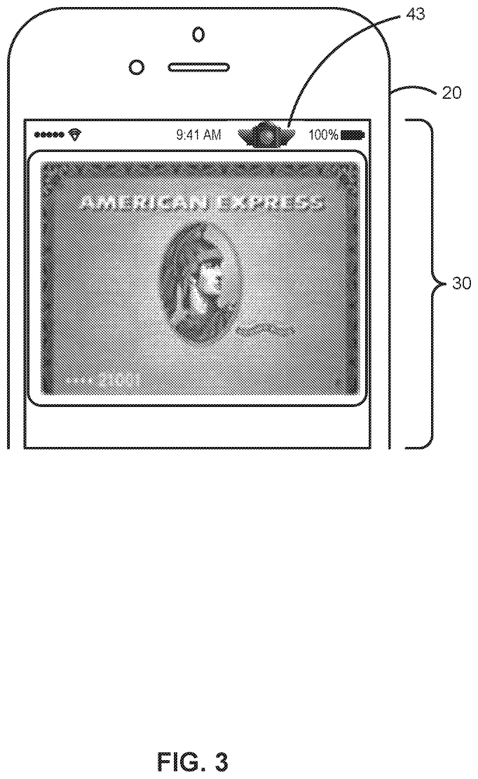

The digital wallet fraud guard agent 40 may comprise a triggered alert indicator 43, wherein the fraud threat assessment may be communicated in a human readable form to the user. For instance, with reference to FIGS. 1 and 3, a triggered alert indicator 43 may comprise a visual display of different colors, each color indicating a relative degree of fraud risk associated with a transaction context.

Turning now from the aspects of the digital wallet fraud guard system 10 that are associated with the mobile device 20, further aspects of the digital wallet fraud guard system 10 are associated with the transaction account provider data center 50. For instance, the digital wallet fraud guard system 10 may comprise a digital wallet fraud guard service 70.

The digital wallet fraud guard service 70 may comprise the aspect of the transaction account provider data center 50 in direct communication via the mobile device communication channel 45 with the digital wallet fraud guard agent 40. In this manner, the system may be developed to be mobile device 20 and/or transaction account provider data center 50 agnostic. For instance, a digital wallet fraud guard agent 40 and/or digital wallet fraud guard service 70 may be developed for implementation on various platforms. In this manner, the functionality of the mobile device communication channel 45 and the digital wallet fraud guard system 10 is improved by virtue of the platform agnostic architecture disclosed herein and the improved interoperability provided thereby. As such, the prevention of fraudulent transactions may be improved even more due to the increase in amount of available data due to the propagation of the digital wallet fraud guard system 10 to various different platforms—capturing a larger installed user base.

The digital wallet fraud guard service 70 may be in electronic communication with a merchant fraud threat database 90 via a threat database communication channel 75. The digital wallet fraud guard service 70 may be in electronic communication with internal back end services 80 via an internal backend services channel 85. The digital wallet fraud guard service 70 may be electronic communication with third party services 60 via a third party service fraud guard channel 63. Thus, the digital wallet fraud guard service 70 may leverage many powerful data sources when determining threat assessment data to be transmitted by the digital wallet fraud guard service 70 to the digital wallet fraud guard agent 40. Moreover, the digital wallet fraud guard service 70 may receive data from the digital wallet fraud guard agent 40 wherein machine learning mechanisms are implemented to identify unknown fraud risks and/or to reevaluate relative risk levels associated with differing transaction contexts. The digital wallet fraud guard service 70 may authenticate a user, such as using a token identifying the transaction account holder and/or transaction account of an electronic credential within the digital wallet 30. The digital wallet fraud guard service 70 may correlate geolocation data to a country, city, zip code, and/or merchant. The digital wallet fraud guard service 70 may retrieve data such as a merchant identifier, city, state, country, fraud information, and/or the like from other data sources and in various embodiments, may coordinate with other services in order to transmit alerts to merchants regarding the instances of fraud arising at the merchant location.

The digital wallet fraud guard system 10 may comprise a merchant fraud threat database 90 as discussed. The merchant fraud threat database 90 may be configured to store threat assessment data in association with threat contexts. The merchant fraud threat database 90 may store data derived from third party services 60 and internal back end services 80 as well. In this manner, the digital wallet fraud guard system 10 may leverage historical data and may implement machine learning so that the threat assessments rendered for different threat contexts may be improved over time, and each specific threat assessment may be derived with the benefit of real-time and/or historical data.

The digital wallet fraud guard system 10 may comprise internal back end services 80 as discussed. The internal back end services 80 may comprise big data services, transaction analytics, transaction account data, transaction account holder data, merchant data and/or the like. Internal back end services 80 may be in direct communication with the digital wallet fraud guard service 70 via a back-end-to-service channel 73. Internal back end services 80 may be in direct communication with the third party services 60 via a third party service backend channel 65. Internal back end services 80 may be in direct communication with the merchant fraud threat database 90 via an internal backend services channel 85.

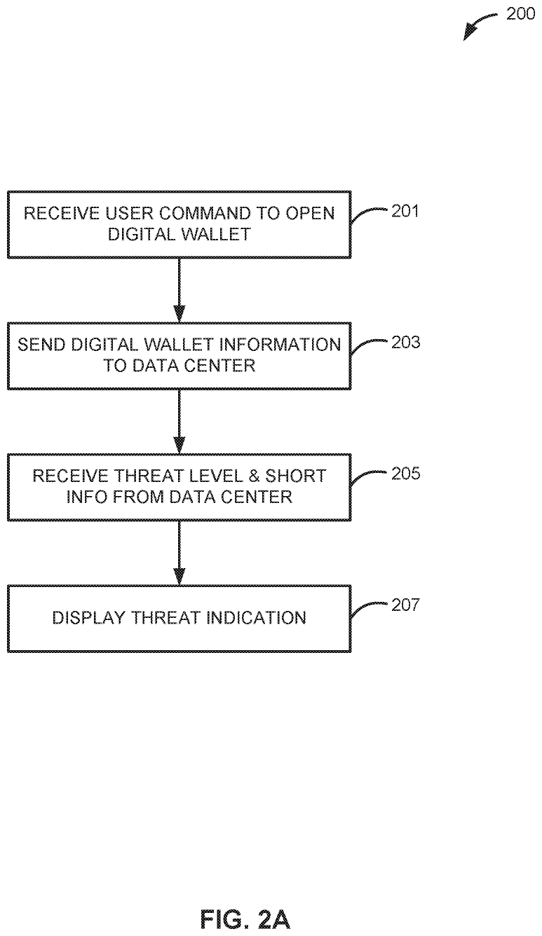

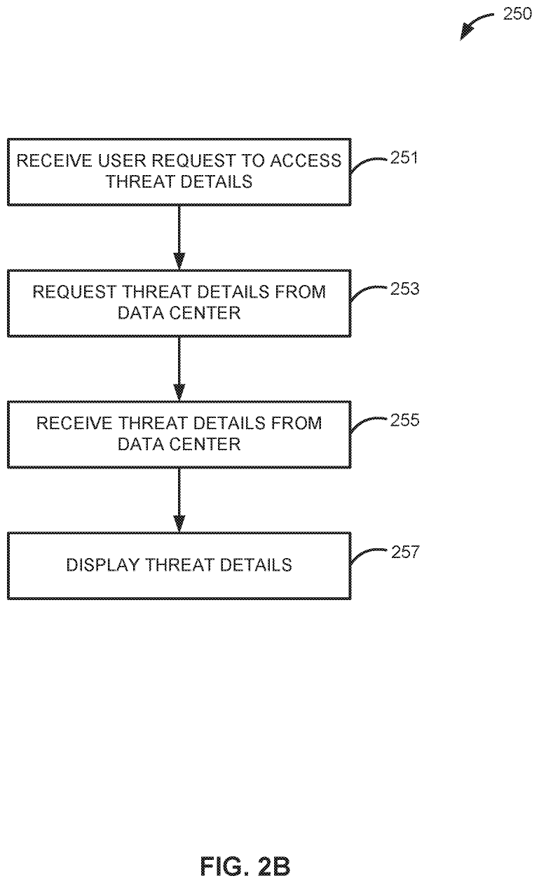

With reference now to FIG. 2A, various methods of digital wallet fraud guard threat indication 200 may be executed by a digital wallet fraud guard system 10. For instance, a digital wallet fraud guard agent 40 may receive a user command to open a digital wallet 30 (step 201). In response to the opening of the digital wallet 30, the digital wallet fraud guard agent 40 may be activated. A digital wallet fraud guard agent 40 associated with the digital wallet 30 may send transaction context information to a transaction account provider data center 50 and specifically, a digital wallet fraud guard service 70 running therein (step 203). The digital wallet fraud guard service 70 may, in communication with at least one of a merchant fraud threat database 90, third party services 60, and internal back end services 80, prepare a threat level and short information. As such, the digital wallet fraud guard agent 40 may receive a threat level and short information from the transaction account provider data center 50 (step 205). In response to the threat level and short information, the digital wallet fraud guard agent 40 may activate a triggered alert indicator 43 configured to display a fraud threat assessment (step 207).

With reference now to FIG. 2B, various methods of digital wallet fraud guard threat detail disclosure 250 may be executed by a digital wallet fraud guard system 10. For example, a digital wallet fraud guard agent 40 may receive a user command to access threat details (step 251). For instance, following step 207 of a method of digital wallet fraud guard threat indication 200, a user may desire additional information in order to assess a potential fraud risk. The user may request threat details. The digital wallet fraud guard agent 40 may transmit a request for threat details to a transaction account provider data center 50, and specifically, a digital wallet fraud guard service 70 running therein (step 253). The digital wallet fraud guard service 70 may, in communication with at least one of a merchant fraud threat database 90, third party services 60, and internal back end services 80, prepare a threat details. As such, the digital wallet fraud guard agent 40 may receive the threat details from the transaction account provider data center 50 (step 255). In response to the threat details, the digital wallet fraud guard agent 40 may display the treat details, such as in association with a text box associated with the triggered alert indicator 43 (step 257).

Data, as discussed herein, may include “internal data.” Internal data may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002) the contents of which are hereby incorporated by reference.

A network may be unsecure. Thus, communication over the network may utilize data encryption. Encryption may be performed by way of any of the techniques now available in the art or which may become available—e.g., Twofish. RSA, El Gamal, Schorr signature, DSA, PGP, PKI, GPG (GnuPG), and symmetric and asymmetric cryptography systems.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YouTube®, AppleTV®, Pandora®, xBox®, Sony® Playstation®), a uniform resource locator (“URL”), a document (e.g., a Microsoft Word® document, a Microsoft Excel® document, an Adobe .pdf document, etc.), an “ebook,” an “emagazine,” an application or microapplication (as described herein), an SMS or other type of text message, an email. Facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, Foursquare®, Twitter®, MySpace®, LinkedIn®, and the like. Examples of affiliate or partner websites include American Express®, Groupon®, LivingSocial®, and the like. Moreover, examples of mobile device communications include texting, email, and mobile applications for smartphones.

A “consumer profile,” “customer data,” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor: a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT®, Windows 95/98/2000®, Windows XP®, Windows Vista®, Windows 7®, OS2, UNIX®, Linux®, Solaris®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, and optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

The various system components may be independently, separately or collectively suitably coupled to the network via data links which includes, for example, a connection to an Internet Service Provider (ISP) over the local loop as is typically used in connection with standard modern communication, cable modem. Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nistgov/publications/nistpubs/800-145/SP800-145.pdf (last visited June 2012), which is hereby incorporated by reference in its entirety.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, “transmit” may include sending electronic data from one system component to another over a network connection. Additionally, as used herein, “data” may include encompassing information such as commands, queries, files, data for storage, and the like in digital or any other form.

The computers discussed herein may provide a suitable website or other Internet-based graphical user interface which is accessible by users. In one embodiment, the Microsoft Internet Information Server (HS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The tem “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Java, JavaScript, VBScript, Macromedia Cold Fusion, COBOL, Microsoft Active Server Pages, assembly, PERL, PHP, awk, Python, Visual Basic, SQL Stored Procedures. PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A digital wallet fraud guard system comprising:
a digital wallet fraud guard agent comprising a process running on a mobile device,
wherein the digital wallet fraud guard agent is configured to monitor a usage of a digital wallet and electronic credentials associated with the digital wallet,
wherein the digital wallet fraud guard agent transmits transaction context data to a mobile device communication channel;
a digital wallet fraud guard service comprising a process running on a transaction account provider data center,
wherein the digital wallet fraud guard service is configured to receive the transaction context data from the mobile device communication channel,
wherein the digital wallet fraud guard service is configured to transmit threat assessment data to the mobile device via the mobile device communication channel, and
wherein the threat assessment data comprises at least one of threat details, threat level, or a short information.

2. The digital wallet fraud guard system according to claim 1, wherein the digital wallet fraud guard agent is configured to provide a fraud threat assessment to a user in response to the threat assessment data.

3. The digital wallet fraud guard system according to claim 1, wherein the transaction context data comprises at least one of geolocation data, a device ID, or a token identifying at least one of a transaction account holder or transaction account of an electronic credential.

4. The digital wallet fraud guard system according to claim 1, wherein the digital wallet fraud guard agent is configured to receive a first user input, the first user input comprising at least one of a selection of a merchant from among a list of merchants in response to geolocation data, or a textual entry of a merchant name, and wherein the transaction context data comprises the first user input.

5. The digital wallet fraud guard system according to claim 1, wherein the digital wallet fraud guard agent comprises a triggered alert indicator, and wherein a fraud threat assessment is communicated in a human readable form to a user.

6. The digital wallet fraud guard system according to claim 5, wherein the triggered alert indicator comprises a visual display of different colors, each of the colors indicating a relative degree of fraud risk.

7. The digital wallet fraud guard system according to claim 1, further comprising a merchant fraud threat database in communication with the digital wallet fraud guard service, wherein the merchant fraud threat database is configured to store a fraud threat assessment in association with the transaction context data.

8. The digital wallet fraud guard system according to claim 1, further comprising internal back end services in direct communication with the digital wallet fraud guard service via a back-end-to-service channel, and wherein the internal back end services comprise at least one of big data services, transaction analytics, transaction account data, transaction account holder data, or merchant data.

9. A method of digital wallet fraud guard threat indication comprising:
receiving, by a digital wallet fraud guard agent, a user command to open a digital wallet;
sending, by the digital wallet fraud guard agent, transaction context data to a digital wallet fraud guard service of a transaction account provider data center, wherein the digital wallet fraud guard service prepares a threat level and a short information;
receiving, by the digital wallet fraud guard agent, the threat level and the short information; and
activating, by the digital wallet fraud guard agent, a triggered alert indicator in response to the threat level and the short information, wherein the triggered alert indicator is configured to display a threat level indication.

10. The method of claim 9, wherein the transaction context data comprises at least one of geolocation data, a device ID, or a token identifying at least one of a transaction account holder or transaction account of an electronic credential.

11. The method of claim 9, wherein the digital wallet fraud guard agent is configured to receive a first user input, the first user input comprising at least one of a selection of a merchant from among a list of merchants in response to geolocation data, and a textual entry of a merchant name, and wherein the transaction context data comprises the first user input.

12. The method of claim 9, wherein the triggered alert indicator communicates a fraud threat assessment in a human readable form to a user.

13. The method of claim 12, wherein the triggered alert indicator comprises a visual display of different colors, each indicating a relative degree of fraud risk.

14. The method of claim 9, wherein the digital wallet fraud guard service is in communication with a merchant fraud threat database configured to store a fraud threat assessment in association with transaction context data.

15. The method of claim 9, wherein the digital wallet fraud guard service is in communication with an internal back end service comprising at least one of big data services, transaction analytics, transaction account data, transaction account holder data, or merchant data.

16. The method of claim 9, further comprising a method of digital wallet fraud guard detail disclosure, comprising:
receiving, by the digital wallet fraud guard agent, the user command to access threat details;
transmitting, by the digital wallet fraud guard agent, a request for the threat details to the digital wallet fraud guard service of the transaction account provider data center, wherein the digital wallet fraud guard service prepares the threat details;
receiving, by the digital wallet fraud guard agent, the threat details; and
displaying, by the digital wallet fraud guard agent, the threat details, in response to the threat details.

17. A method of digital wallet fraud guard detail disclosure comprising:
receiving, by a digital wallet fraud guard agent, a user command to access threat details;
transmitting, by the digital wallet fraud guard agent, a request for the threat details to a digital wallet fraud guard service of a transaction account provider data center, wherein the digital wallet fraud guard service prepares the threat details;
receiving, by the digital wallet fraud guard agent, the threat details; and
displaying, by the digital wallet fraud guard agent, the threat details, in response to the threat details.

18. A method of claim 17, wherein the digital wallet fraud guard agent is configured to receive a first user input comprising at least one of a selection of a merchant from among a list of merchants in response to geolocation data, or a textual entry of a merchant name, and wherein the threat details are associated with the selected merchant.

19. The method of claim 17, wherein a triggered alert indicator communicates the threat details in a human readable form to a user.

20. The method of claim 17, wherein the digital wallet fraud guard service is in communication with a merchant fraud threat database configured to store the threat details in association with transaction context data.
